(19) United States
(12) Patent Application Publication
(10) Pub. No.: US 2024/0127109 A1
(43) Pub. Date: Apr. 18, 2024

(54) FEDERATED LEARNING METHOD AND SYSTEM

(71) Applicant: INSTITUTE FOR INFORMATION INDUSTRY, Taipei City (TW)

(72) Inventors: Ping Feng WANG, Taipei City (TW); Chiun Sheng HSU, Taipei City (TW); Chi-Yuan CHOU, Taipei City (TW); Fu-Chiang CHANG, Taipei City (TW)

(73) Assignee: INSTITUTE FOR INFORMATION INDUSTRY, Taipei City (TW)

(21) Appl. No.: 17/985,106

(22) Filed: Nov. 10, 2022

(30) Foreign Application Priority Data
Oct. 12, 2022 (TW) 111138637

(51) Int. Cl. G06N 20/00

(52) U.S. Cl. CPC G06N 20/00

(57) ABSTRACT

A federated learning method includes: providing importance parameters and performance parameters by client devices respectively to a central device, performing a training procedure by the central device, wherein the training procedure includes: selecting target devices from the client devices according to a priority order associated with the importance parameters, dividing the target devices into training groups according to a similarity of the performance parameters, notifying the target devices to perform iterations according to the training groups respectively to generate trained models, transmitting the trained models to the central device, and updating a global model based on the trained models, performing the training procedure again or outputting the global model to the client devices based on a convergence value of the global model and the number of times of performing the training procedure.

### CROSS-REFERENCE TO RELATED APPLICATIONS

This non-provisional application claims priority under 35 U.S.C. § 119(a) on Patent Application No(s). 111138637 filed in Republic of China (ROC) on Oct. 12, 2022, the entire contents of which are hereby incorporated by reference.

### BACKGROUND

### 1. Technical Field

This disclosure relates to a federated learning method and system, especially to a federated learning method and system of selecting client devices though importance parameters and performance parameters.

### 2. Related Art

In federated learning, data do not need to leave client devices, but instead, models can be trained at client devices, and build a common model can be built and updated. Therefore, federated learning not only protects privacy, but also reduce the cost of transmitting large amount of data.

However, due to the different data quality and data volume among the selected client devices, under the traditional method of selecting client devices to participate in training with the same probability, the client devices with poor data quality or less data volume will reduce the learning efficiency of model training. In addition, the different hardware specifications and network speeds of the selected client devices will also cause the client device that learns quickly to cooperate with the server to wait for client devices that learn slowly to return the models, and can only continue the training of next round after compiling the global model is compiled, thereby delaying the overall training time of the federated learning model.

### SUMMARY

Accordingly, this disclosure provides a federated learning method and system for solving above problems.

According to one or more embodiment of this disclosure, a federated learning method includes: providing a number of importance parameters and a number of performance parameters by a number of client devices respectively to a central device; and performing a training procedure by the central device, wherein the training procedure includes: selecting a number of target devices from the client devices according to a priority order associated with the importance parameters; dividing the target devices into a number of training groups according to a similarity of the performance parameters; notifying the target devices to perform a number of iterations according to the training groups respectively to generate a number of trained models, and transmitting the trained models back to the central device; and updating a global model based on the trained models; when a convergence value of the global model does not fall within a default range or a number of times of performing the training procedure does not reach a default number, performing the training procedure again by the central device; and when the convergence value of the global model falls within the default range and the number of times of performing the training procedure reaches the default number, outputting the global model to the client devices by the central device.

According to one or more embodiment of this disclosure, a federated learning system includes: a number of client devices having a number of importance parameters and a number of performance parameters, respectively; and a central device connected to the client devices, configured to obtain the importance parameters and the performance parameters, and perform a training procedure repeatedly until a convergence value of a global model of the central device falls within a default range and a number of times of performing the training procedure reaches a default number to output the global model to the client devices; wherein the training procedure includes: selecting a number of target devices from the client devices according to a priority order associated with the importance parameters; dividing the target devices into a number of training groups according to a similarity of the performance parameters; notifying the target devices to perform a number of iterations according to the training groups respectively to generate a number of trained models, and transmitting the trained models back to the central device; and updating the global model based on the trained models.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a federated learning system according to an embodiment of the present disclosure;

FIG. 2 is a flowchart illustrating a federated learning method according to an embodiment of the present disclosure;

FIG. 3 is a flowchart illustrating an embodiment of step S203 of FIG. 2;

FIG. 4 is a flowchart illustrating an embodiment of step S205 of FIG. 2;

FIG. 5 is a flowchart illustrating an embodiment of step S209 of FIG. 2;

FIG. 6 is a flowchart illustrating a federated learning method according to another embodiment of the present disclosure;

FIG. 7A presents a schematic diagram of comparing the training duration required for client devices in the case of grouping client devices randomly; FIG. 7B presents a schematic diagram of comparing the training duration required for client devices in the case of grouping client devices according to embodiments of the present disclosure; and

FIG. 8A is a schematic diagram illustrating the cumulative duration of training performing by randomly grouped client devices; FIG. 8B is a schematic diagram illustrating the cumulative duration of training performing by client devices grouped according to embodiments of the present disclosure; FIG. 8C is a schematic diagram illustrating the total duration of training performing by client devices grouped according to embodiments of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

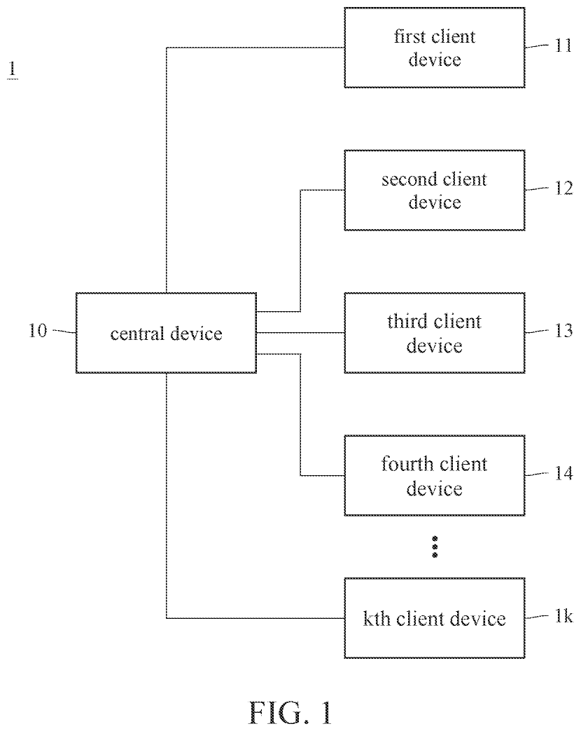

Please refer to FIG. 1, FIG. 1 is a block diagram illustrating a federated learning system according to an embodiment of the present disclosure. As shown in FIG. 1, the federated learning system 1 according to an embodiment of the present disclosure includes a first client device 11, a second client device 12, a third client device 13, a fourth client device 14 to the kth client device 1k and a central device 10. The central device 10 may be connected to the first client device 11 to the kth client device 1k respectively through Internet or other network. The first client device 11 to the kth client device 1k and the central device 10 may each include but not limited to a single processor and an integration of a number of microprocessors, such as a central processing unit (CPU), a graphics processing unit (GPU) etc. The central device 10 may be a sever in a federated learning structure, and the first client device 11 to the kth client device 1k may be local devices in the federated learning structure, such as a computer, a smart phone and a tablet etc. of a user. The first client device 11 to the kth client device 1k each has an importance parameter and a performance parameter, and each stores a local model. The central device 10 stores a global model; may obtain the importance parameters and the performance parameters of the first client device 11 to the kth client device 1k to select target devices participating in training; performs grouping on the target devices to perform training; obtains training result of each target device to update the global model; and performs multiple rounds of said training and updating and provides the updated global model to the first client device 11 to the kth client device 1k after determining that the updated global model converges. The details are described below. It should be noted that, FIG. 1 schematically illustrates the federated learning system 1 having five client devices, and is not used to limit the present disclosure. In other embodiments, the number of client devices of the federated learning system may be equal to or greater than 2.

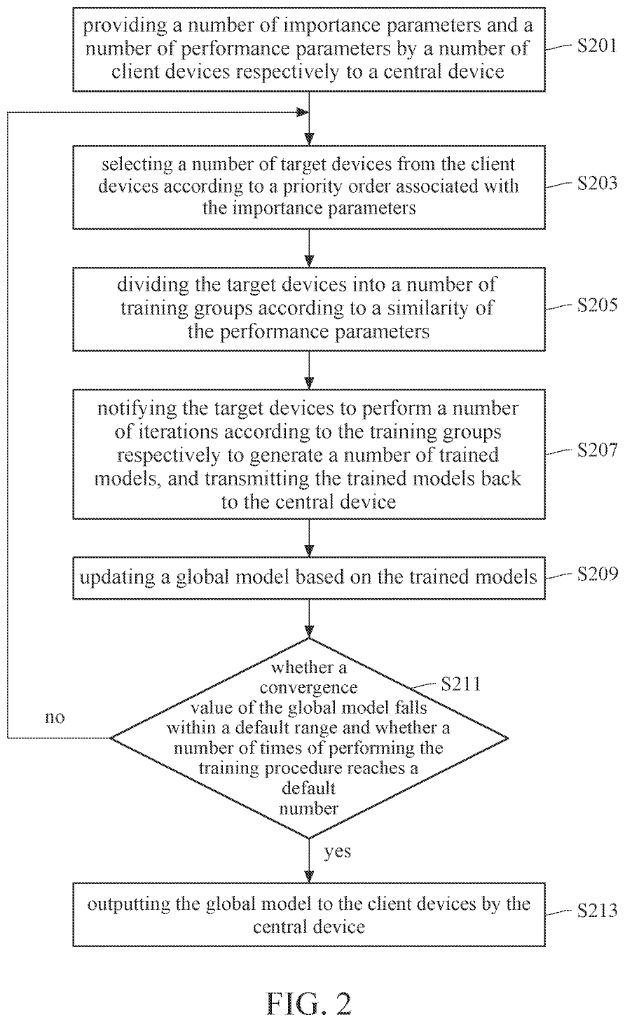

To describe the federated learning system and method according to embodiments of the present disclosure in more detail, please refer to FIG. 1 and FIG. 2, wherein FIG. 2 is a flowchart illustrating a federated learning method according to an embodiment of the present disclosure. As shown in FIG. 2, the federated learning method according to an embodiment of the present disclosure includes: step S201: providing a number of importance parameters and a number of performance parameters by a number of client devices respectively to a central device; step S203: selecting a number of target devices from the client devices according to a priority order associated with the importance parameters; step S205: dividing the target devices into a number of training groups according to a similarity of the performance parameters; step S207: notifying the target devices to perform a number of iterations according to the training groups respectively to generate a number of trained models, and transmitting the trained models back to the central device; step S209: updating a global model based on the trained models; step S211: determining whether a convergence value of the global model falls within a default range and whether a number of times of performing the training procedure reaches a default number; if a determination result of step S211 is “yes”, performing step S213: outputting the global model to the client devices by the central device; and step S211 if a determination result of step S211 is “no”, performing step S203. The following uses the federated learning system 1 shown in FIG. 1 to further elaborate the federated learning method shown in FIG. 2.

In step S201, all of the client devices 11 to 1k in communication connection with the central device 10 provides a respective one of the importance parameters and the performance parameters to the central device 10. The importance parameter may indicate a level of contribution of the client device on generating the global model, and the performance parameter may indicate a cost of the client device during each iteration.

For example, the importance parameter may include a loss value or a gradient value of the local model of respective one of the client devices, wherein the loss value is preferably a root mean square error or a mean square error. Moreover, the loss value may represent an error between predicted data of the local model and actual data, and the gradient value may be generated through back propagation on the loss value. The importance parameter may be obtained through the equation (1) or equation (2) below. In equation (1), importanceᵢ is the importance parameter of the i^{th} client device; Loss(p) is the loss value of the i^{th} client device; Dᵢ is a total amount of data in the dataset of the i^{th} client device, wherein an importance of a client device is higher when the total amount of data is higher. In equation (2), importanceᵢ is the importance parameter of the i^{th} client device; g(p) is the gradient value of the i^{th} client device; Dᵢ is a total amount of data in the dataset of the i^{th} client device, wherein an importance of a client device is higher when the total amount of data is higher.

$${importance}_{i} = \vert {D}_{i} \vert \sqrt{\frac{1}{\vert {D}_{i} \vert} {\sum }_{p ϵ {D}_{i}} Loss {( p )}^{2}} \qquad equation ( 1 )$$

$$impo r t {ance}_{i} = \vert {D}_{i} \vert \sqrt{\frac{1}{\vert {D}_{i} \vert} {\sum }_{p ϵ {D}_{i}} {‖ g ( p ) ‖}^{2}} \qquad equation ( 2 )$$

For the performance parameter, the central device 10 may sample system log of each of the first client device 11 to the kth client device 1k in advance to obtain the performance parameter. For example, the performance parameter may be at least one of an inferring duration of the client device using a local model, an inferring speed (for example, frame rate (FPS)) using a local model and connection information (for example, connection speed, connection strength). The first client device 11 to the kth client device 1k each may reregister at the central device 10 in advance, and transmits their respective importance parameters and performance parameters to the central device 10.

The central device 10 may perform the training procedure according to the importance parameters and the performance parameters obtained from the client devices 11 to 1k, wherein one training procedure may be regarded as one training round, and the training procedure includes step S203, S205, S207 and S209. In step S203, the central device 10 selects target devices from the first client device 11 to the kth client device 1k according to the high-to-low order of the importance parameters of all client devices 11 to 1k. For example, the central device 10 may select a predetermined number of client devices from the first client device 11 to the kth client device 1k as the target devices, and the importance parameters of all target devices are greater than the importance parameters of unselected client devices. For better understanding, the following assumes that the first client device 11 to the fourth client device 14 are selected as the target devices.

In step S205, the central device 10 divides a number of client devices having similar performance parameters among the first client device 11 to the fourth client device 14 as a number of training groups, for each training group having target devices with similar performance parameters. For better understating, the following assumes that the first client device 11 and the second client device 12 are divided into a first training group, and the third client device 13 and the fourth client device 14 are divided into a second training group.

In step S207, the central device 10 notifies the first training group and the second training group to perform a number of iterations, respectively. Specifically, the central device notifies the first client device 11 and the second client device 12 belonging to the first 10 training group to perform a predetermined number of times of the iteration together using their respective local models, and notifies the third client device 13 and the fourth client device 14 belonging to the second training group to perform a predetermined number of times of the iteration together using their respective local models. For example, the central device notifies the first training group and the second training group to perform E times of Epoch training (the iteration), wherein E is any positive integer that is not smaller than 2. Then, each of the first client device 11 to the fourth client device 14 transmits the generated trained model back to the central device 10. In the present embodiment, each of the training groups may have a same number of target devices, but the present disclosure is not limited thereto.

In step S209, the central device 10 compiles the trained models to update the global model. In addition, since the first client device 11 to the fourth client device 14 may have different training speeds, timings of the first client device 11 to the fourth client device 14 transmitting their respective trained models back to the central device 10 may also be different. Therefore, the central device 10 may update the global model when receiving the trained models transmitted from some of the target devices, the central device 10 may also update the global model after receiving the trained models transmitted from all of the target devices.

In step S211, the central device 10 calculates the convergence value of the global model, and calculates the number of times of performing the training procedure (the number of times of performing step S203, S205, S207 and S209), and determines whether the convergence value falls within the default range and the number of times of performing the training procedure reaches the default number, wherein said “reach” in the present disclosure indicates “equal to or greater than”. In other words, in step S211, the central device 10 checks whether the global model converges and checks whether the number of training rounds reaches the default number. The detail of calculating said the convergence value is known by a person ordinarily skilled in the art, and is not described herein. Said default number may be designed according to different requirements, and the present disclosure does not limit the actual numerical value of default number.

If the central device 10 determines that the convergence value of the global model does not fall within the default range or that the number of times of performing the training procedure does not reach the default number, the central device 10 performs the training procedure (S203, S205, S207 and S209) and step S211 again. If the central device 10 determines that the convergence value of the global model falls within the default range and that the number of times of performing the training procedure reaches the default number, the central device 10 performs step S213 to output the updated global model to the first client device 11 to the kth client device 1k.

In other words, in the embodiment of FIG. 2, the central device 10 performs the training procedure repeatedly until the convergence value of the global model of the central device 10 falls within the default range and the number of times of performing the training procedure reaches the default number, and then outputs the global model to the client devices 11 to 1k.

Through the federated learning system and method according to the above embodiments, by selecting target devices according to the importance parameter, the client device with better data quality has higher chance of being selected, thereby solving the problem of unbalanced training data and improving model training accuracy. In addition, by grouping the target devices according to the performance parameters, the client devices with larger performance differences may be prevented from participating in the same round of training, thereby reducing the time delay caused by synchronous calculation, and achieving the purpose of shortening the training duration.

Please refer to FIG. 1 and FIG. 3, wherein FIG. 3 is a flowchart illustrating an embodiment of step S203 of FIG. 2. As shown in FIG. 3, step S203 of FIG. 2 may include: step S301: sorting a number of values associated with the importance parameters respectively from high to low; and step S303: using N client devices corresponding to a first value to a Nth value among the values sorted from high to low as the target devices, wherein N is a positive integer that is equal to or greater than 2.

In step S301, the central device 10 sorts the values of the importance parameters of the first client device 11 to the kth client device 1k from high to low. Then, in step S302, the central device 10 uses the client devices corresponding to a first value to a Nth value among the values that are sorted from high to low as the target devices, wherein N may be the predetermined number described above. Further, the predetermined number may be obtained through the following equation (3). In equation (3), C is a parameter that is greater than 0 and not greater than 1, the detail of the parameter C may be set based on requirements; n is the number of the client devices that are connected to the central device 10, wherein n equals to k in this example; and U is a set of the client devices that are connected to the central device 10. During the training process, the number of client devices may vary due to connection problems or operating problems of the devices themselves, so the value of the predetermined number [C*n(U)] used for each training round may vary.

[C×n(U)] equation (3)

Except for directly sorting the values of the importance parameters, an implementation of step S301 may be: performing calculation on the importance parameters of the first client device 11 to the kth client device 1k to generate a number of importance ratios corresponding to the first client device 11 to the kth client device 1k respectively, and then sorting the importance ratios from high to low. Specifically, the central device 10 uses each of the first client device 11 to the kth client device 1k as a candidate device to calculate the importance ratio between an importance parameter, among all importance parameters, belonging to the candidate device and a sum of all importance parameters, and uses the importance ratio as one of the values associated with the importance parameters.

The importance ratio may be calculated through the following equation (4). ρᵢ is the importance ratio of the i^{th} candidate device among the first client device 11 to the kth client device 1k; imptᵢ is the importance parameter of the i^{th} candidate device among the first client device 11 to the kth client device 1k; and Σ_{k∈U}|imptₖ| is a sum of the importance parameters of the first client device 11 to the kth client device 1k.

$${ρ}_{i} = \frac{\vert {impt}_{i} \vert}{{\sum }_{k ϵ U} \vert {impt}_{k} \vert} \qquad equation ( 4 )$$

After the importance ratios are calculated, the central device 10 may use each of the importance ratios as the value of the importance parameter of the corresponding client device to perform said priority sorting.

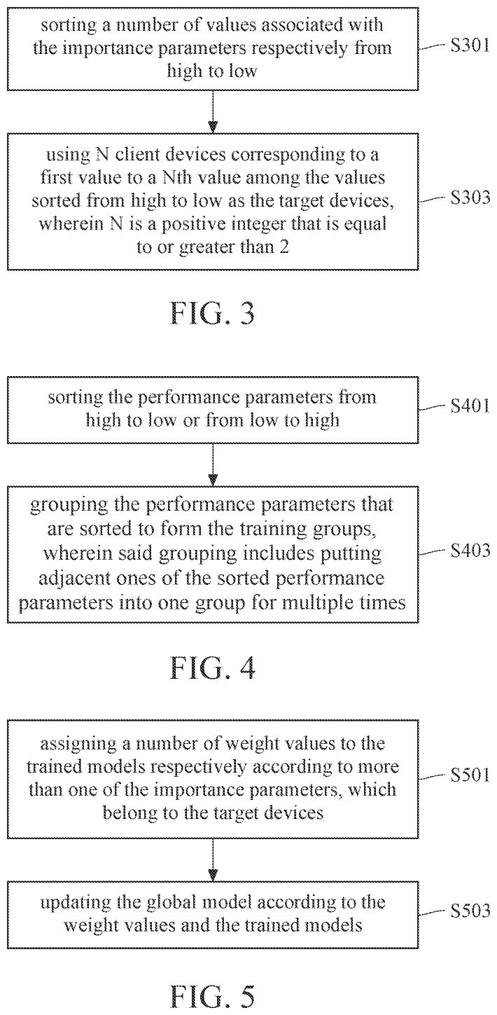

Please refer to FIG. 1 and FIG. 4, wherein FIG. 4 is a flowchart illustrating an embodiment of step S205 of FIG. 2. As shown in FIG. 4, step S205 of FIG. 2 may include: step S401: sorting the performance parameters from high to low or from low to high; and step S403: grouping the performance parameters that are sorted to form the training groups, wherein said grouping includes categorizing adjacent ones of the sorted performance parameters into one group for multiple times.

In step S401, the central device 10 may sort the performance parameters from high to low or from low to high. In step S403, the central device 10 groups the sorted performance parameter to form the training groups, wherein the performance parameters among one training group are similar to each other. For example, assuming that the performance parameters corresponding to the first client device 11 to the fourth client device 14 respectively are a first performance parameter to a fourth performance parameter, and the order of these performance parameters from high to low is the second performance parameter, the third performance parameter, the first performance parameter and the fourth performance parameter, then in this example, the central device 10 uses the client devices corresponding to the second performance parameter and the third performance parameter to form one training group, and uses the client devices corresponding to the first performance parameter and the fourth performance parameter to form another training group, the present disclosure does not limit the number of client devices in one training group. Therefore, the client devices in one training group may have similar performance parameters, and may finish one iteration at similar timing.

Please refer to FIG. 1 and FIG. 5, wherein FIG. 5 is a flowchart illustrating an embodiment of step S209 of FIG. 2. As shown in FIG. 5, step S209 of FIG. 2 may include: step S501: assigning a number of weight values to the trained models respectively according to more than one of the importance parameters, which belong to the target devices; and step S503: updating the global model according to the weight values and the trained models.

In step S501, the central device 10 may assign the weight values to each of the trained models of the target devices, and the weight values correspond to the importance parameters of the target devices respectively. Take the first client device 11 as the target device for example, the first client device 11 has a first importance parameter, the central device 10 assigns a weight value corresponding to the first importance parameter to the trained model generated by the first client device 11. In other words, when the importance parameter of the target device is higher, the weight value of the trained model generated by the target device is also higher. Furthermore, the importance parameter and the weight value may be positively correlated. In step S503, the central device 10 may update the global model according to the trained models and the corresponding weight values. Specifically, the central device 10 may multiply each trained model with the corresponding weight value, and use a sum of the trained models multiplied with the weight values as the updated global model. The configuration of the weight values described in step S501 is merely an example, the present disclosure is not limited thereto, but by configuring the weight values according to the importance parameters, the updated global model generated by the central device 10 may have a better degree of convergence.

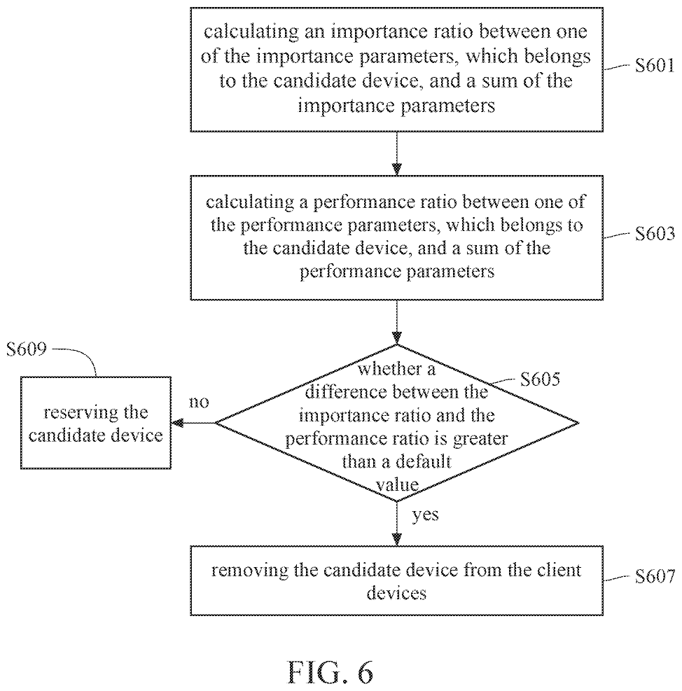

Please refer to FIG. 1 and FIG. 6, wherein FIG. 6 is a flowchart illustrating a federated learning method according to another embodiment of the present disclosure. Steps shown in FIG. 6 may be performed between step S201 and step S203 of FIG. 2. Furthermore, steps shown in FIG. 6 may be performed before sorting the values associated with the importance parameters, and may also be performed after sorting the values associated with the importance parameters. As shown in FIG. 6, in addition to the above embodiments, the federated learning method according to another embodiment may further include, by the central device 10, using each of the first client device 11 to the kth client device 1k as the candidate device and performing: step S601: calculating an importance ratio between one of the importance parameters, which belongs to the candidate device, and a sum of the importance parameters; step S603: calculating a performance ratio between one of the performance parameters, which belongs to the candidate device, and a sum of the performance parameters; step S605: determining whether a difference between the importance ratio and the performance ratio is greater than a default value; if the determination result of step S605 is “yes”, performing step S607: removing the candidate device from the client devices; and if the determination result of step S605 is “no”, performing step S609: reserving the candidate device.

In step S601, the central device 10 may calculate the importance ratio of each candidate device relative to all of the candidate devices through equation (4) above. In step S603, the central device 10 may calculate the performance ratio through the following equation (5). eᵢ is the importance ratio of the i^{th} candidate device among the first client device 11 to the kth client device 1k; timeᵢ is the performance parameter of the i^{th} candidate device among the first client device 11 to the kth client device 1k; Σ_{k∈U}|timeₖ| is a sum of the performance parameters of the first client device 11 to the kth client device 1k.

$${e}_{i} = \frac{\vert {time}_{i} \vert}{{\sum }_{k ϵ U} \vert {time}_{k} \vert} \qquad equation ( 5 )$$

The performance parameter in equation (5) is the inferring duration described above, but the inferring duration in equation (5) may also be replaced with the inferring speed and/or the connection information described above. For better understanding, the following uses the first client device 11 as the candidate device for example.

In step S605, the central device 10 calculates a difference between the importance ratio of the first client device 11 and the performance ratio of the first client device 11 to determine whether said difference is greater than the default value. Specifically, the central device 10 may perform step S605 through the following equation (6), wherein δ is an adjustable parameter, used for controlling the tolerance of the training duration ratio. If the training duration is exceeded, the client device is removed, otherwise it is reserved. Parameter δ may be positive or negative, depending on the training speed of the client device. For example, if training durations of multiple client devices are short, to ensure the diversity of training data, parameter δ may be adjusted to be higher to wait for more training data of a few more client devise whereas the entire training duration may still be maintained in a reasonable range; on the contrary, if the training duration is too long, parameter δ may be adjusted to be lower to reduce the number of client devices for speeding up the operations. That is, the difference is a value obtained by dividing the performance ratio with the importance ratio, and the coefficient (1+δ) is the default value.

$$\frac{\vert {time}_{i} \vert}{{\sum }_{k ϵ U} \vert {time}_{k} \vert} > ( 1 + δ ) \frac{\vert {impt}_{i} \vert}{{\sum }_{k ϵ U} \vert {impt}_{k} \vert} \qquad equation ( 6 )$$

If the importance ratio and the performance ratio of the first client device 11 matches the condition of equation (6), it may mean that the required training duration is disproportionate to the importance of training result of the first client device 11. For example, when the importance ratio and the performance ratio of the first client device 11 matches the condition of equation (6), it may mean that the first client device 11 has either bad or good importance parameter, but the required training duration is too long, which causes the cost of training of the first client device 11 to be too high. Therefore, the central device 10 may perform step S607 to remove the first client device 11 from the first client device 11 to the kth client device 1k, meaning the first client device 11 is not used as a candidate for the target device.

On the contrary, if the importance ratio and the performance ratio of the first client device 11 does not match the condition of equation (6), it may mean that the required training duration matches the importance of training result of the first client device 11, and the central device 10 may perform step S609 to reserve the first client device 11 as a candidate for the target device. Accordingly, the client device with importance that is not high enough and requires higher cost for training may be removed, thereby improving training efficiency.

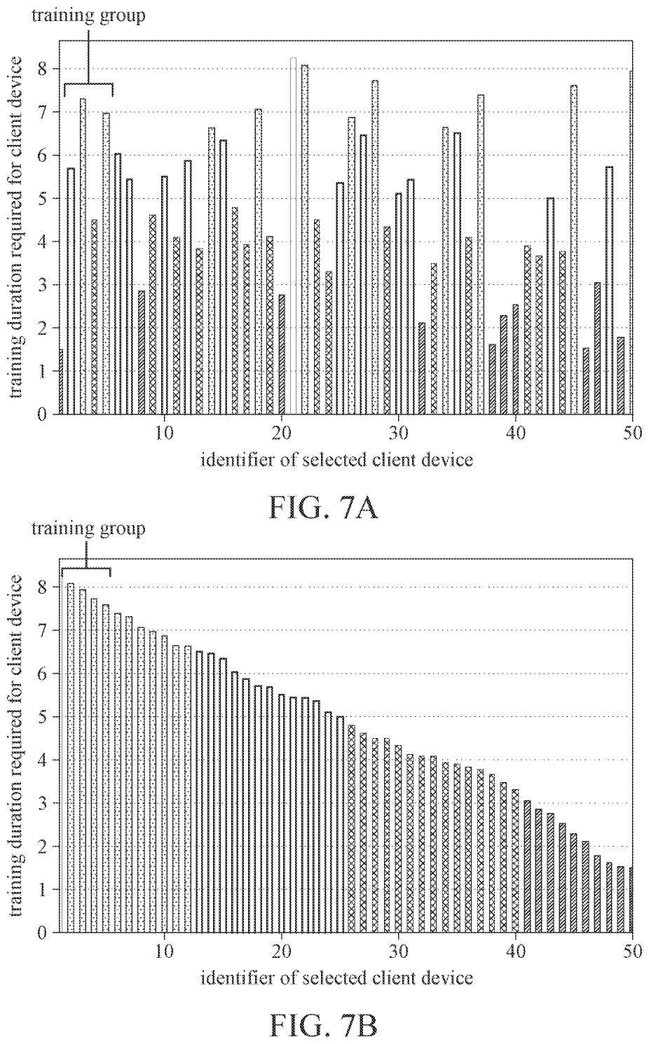

Please refer to FIG. 7A and FIG. 7B, wherein FIG. 7A presents a schematic diagram of comparing the training duration required for client devices in the case of grouping client devices randomly; and FIG. 7B presents a schematic diagram of comparing the training duration required for client devices in the case of grouping client devices according to embodiments of the present disclosure.

As shown in FIG. 7A, if differences between training durations of the client devices are not taken into consideration, the client devices grouped into the same training group will have greater differences in training durations. Under this circumstance, in the same training group, the client device with shorter training duration has to wait for the client device with longer training duration to finish training, resulting in a longer total training duration of all training groups. On the contrary, as shown in FIG. 7B, if differences between training durations of the client devices are taken into consideration, the client devices in the same training group have similar training durations, thereby reducing the waiting duration for the client device with shorter training duration, resulting in a shorter total training duration of all training groups, wherein FIG. 7B may correspond to the method sorting the performance parameters from high to low or from low to high as described above.

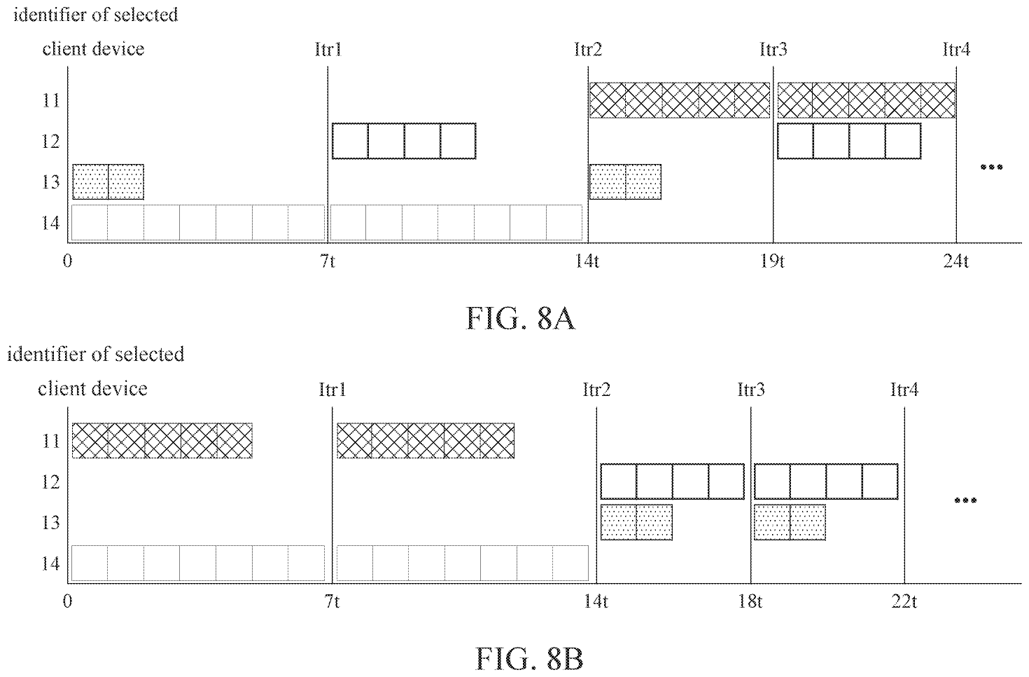

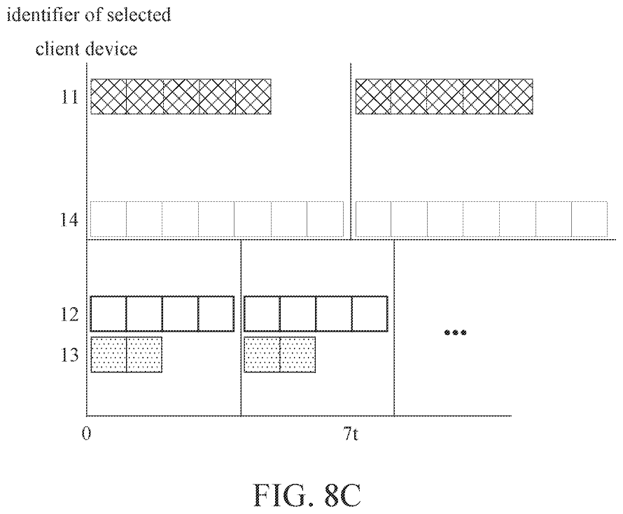

Please refer to FIG. 8A, FIG. 8B and FIG. 8C, wherein FIG. 8A is a schematic diagram illustrating the cumulative duration of training performing by randomly grouped client devices; FIG. 8B is a schematic diagram illustrating the cumulative duration of training performing by client devices grouped according to embodiments of the present disclosure; and FIG. 8C is a schematic diagram illustrating the total duration of training performing by client devices grouped according to embodiments of the present disclosure. The unit of the horizontal axis in FIG. 8A to FIG. 8C is time, wherein “t” represents one time unit. “Itr” shown in FIG. 8A to FIG. 8C represents one iteration.

As shown in FIG. 8A, if differences between training durations of the client devices are not taken into consideration (corresponding to the situation of FIG. 7A), it is possible that the third client device 13 and the fourth client device 14 with large difference in training durations are grouped into the same training group, causing the third client device 13 has to wait for the fourth client device 14 to finish training. Therefore, the cumulative length of time for the first client device 11 to the fourth client device 14 to finish four iteration is 24 units of time.

As shown in FIG. 8B, if differences between training durations of the client devices are taken into consideration (corresponding to the situation of FIG. 7B), the first client device 11 and the fourth client device 14 with small difference in training durations are grouped into the same training group. Therefore, the first client device 11 does not have to wait too long for the fourth client device 14 to finish training (same for the second client device 12 and the third client device 13). Therefore, the cumulative length of time for the first client device 11 to the fourth client device 14 to finish four iteration is only 22 units of time. Accordingly, it can be known from FIG. 8A and FIG. 8B that, the federated learning method and system according to embodiments of the present disclosure may group the client devices, and thereby effectively reducing the cumulative time to finish training.

The example shown in FIG. 8C is the training groups performing training synchronously. As shown in FIG. 8C, in this way, the time required to finish training may be further reduced.

In view of the above description, the federated learning method and system according to one or more embodiments of the present disclosure may allow a client device with higher data quality to have a higher chance of being selected, thereby solving the problem of unbalanced training data and improving model training accuracy. In addition, by grouping the target devices according to the performance parameters, the client devices with larger performance differences may be prevented from participating in the same round of training, thereby reducing the time delay caused by synchronous calculation, and achieving the purpose of shortening the training duration. Accordingly, the federated learning method and system according to one or more embodiments of the present disclosure may generate an accurate model with lower training cost. In addition, according to one or more embodiments of the present disclosure, a client device with disproportional importance ratio and performance ratio may be removed and a client device with enough importance and lower training cost may be reserved as the target device for performing the training procedure, thereby improving training efficiency.

What is claimed is:

1. A federated learning method, comprising:
providing a plurality of importance parameters and a plurality of performance parameters by a plurality of client devices respectively to a central device; and
performing a training procedure by the central device, wherein the training procedure comprises:
selecting a plurality of target devices from the client devices according to a priority order associated with the importance parameters;
dividing the target devices into a plurality of training groups according to a similarity of the performance parameters;
notifying the target devices to perform a plurality of iterations according to the training groups respectively to generate a plurality of trained models, and transmitting the trained models back to the central device; and
updating a global model based on the trained models;
when a convergence value of the global model does not fall within a default range or a number of times of performing the training procedure does not reach a default number, performing the training procedure again by the central device; and
when the convergence value of the global model falls within the default range and the number of times of performing the training procedure reaches the default number, outputting the global model to the client devices by the central device.

2. The federated learning method according to claim 1, wherein selecting the target devices from the client devices according to the priority order associated with the importance parameters comprises:
sorting a plurality of values associated with the importance parameters respectively from high to low; and
using N client devices corresponding to a first value to a Nth value among the values sorted from high to low as the target devices, wherein N is a positive integer that is equal to or greater than 2.

3. The federated learning method according to claim 2, wherein sorting the values associated with the importance parameters respectively from high to low comprises:
using each of the client devices as a candidate device and performing:
calculating an importance ratio between one of the importance parameters, which belongs to the candidate device, and a sum of the importance parameters; and
using the importance ratio as one of the values.

4. The federated learning method according to claim 1, wherein dividing the target devices into the training groups according to the similarity of the performance parameters comprises:
sorting the performance parameters from high to low or from low to high; and
grouping the performance parameters that are sorted to form the training groups, wherein said grouping comprises putting adjacent ones of the sorted performance parameters into one group for multiple times.

5. The federated learning method according to claim 1, wherein each of the training groups comprises more than one target device among the target devices, and notifying the target devices to perform the iterations according to the training groups respectively to generate the trained models comprises:
notifying the target devices belonging to a same training group to perform the iterations during a same training period.

6. The federated learning method according to claim 1, further comprising:
before selecting the target devices from the client devices according to the priority order associated with the importance parameters, by the central device, using each of the client devices as a candidate device and performing:
calculating an importance ratio between one of the importance parameters, which belongs to the candidate device, and a sum of the importance parameters;
calculating a performance ratio between one of the performance parameters, which belongs to the candidate device, and a sum of the performance parameters; and
removing the candidate device from the client devices when a difference between the importance ratio and the performance ratio is greater than a default value.

7. The federated learning method according to claim 1, wherein updating the global model based on the trained models comprises:
assigning a plurality of weight values to the trained models respectively according to more than one importance parameters belonging to the target devices among the importance parameters provided by the client devices; and
updating the global model according to the weight values and the trained models.

8. The federated learning method according to claim 1, wherein each of the importance parameters comprises a loss value or a gradient value of a local model of a respective one of the client devices.

9. The federated learning method according to claim 1, wherein each of the performance parameters comprises at least one of an inferring duration, an inferring speed of using a local model and connection information of a respective one of the client devices.

10. A federated learning system, comprising:
a plurality of client devices having a plurality of importance parameters and a plurality of performance parameters, respectively; and
a central device connected to the client devices, configured to obtain the importance parameters and the performance parameters, and perform a training procedure repeatedly until a convergence value of a global model of the central device falls within a default range and a number of times of performing the training procedure reaches a default number to output the global model to the client devices;
wherein the training procedure comprises:
selecting a plurality of target devices from the client devices according to a priority order associated with the importance parameters;
dividing the target devices into a plurality of training groups according to a similarity of the performance parameters;
notifying the target devices to perform a plurality of iterations according to the training groups respectively to generate a plurality of trained models, and transmitting the trained models back to the central device; and
updating the global model based on the trained models.

11. The federated learning system according to claim 10, wherein the central device performing selecting the target devices from the client devices according to the priority order associated with the importance parameters comprises:
sorting a plurality of values associated with the importance parameters respectively from high to low; and
using N client devices corresponding to a first value to a Nth value among the values sorted from high to low as the target devices, wherein N is a positive integer that is equal to or greater than 2.

12. The federated learning system according to claim 11, wherein the central device performing sorting the values associated with the importance parameters respectively from high to low comprises:
using each of the client devices as a candidate device and performing:
calculating an importance ratio between one of the importance parameters, which belongs to the candidate device, and a sum of the importance parameters; and
using the importance ratio as one of the values.

13. The federated learning system according to claim 10, wherein the central device performing dividing the target devices into the training groups according to the similarity of the performance parameters comprises:
sorting the performance parameters from high to low or from low to high; and
grouping the performance parameters that are sorted to form the training groups, wherein said grouping comprises putting adjacent ones of the sorted performance parameters into one group for multiple times.

14. The federated learning system according to claim 10, wherein each of the training groups comprises more than one target device among the target devices, and the central device notifies the target devices belonging to a same training group to perform the iterations during a same training period.

15. The federated learning system according to claim 10, wherein before selecting the target devices from the client devices according to the priority order associated with the importance parameters, the central device is further configured to use each of the client devices as a candidate device and perform:
calculating an importance ratio between one of the importance parameters, which belongs to the candidate device, and a sum of the importance parameters;
calculating a performance ratio between one of the performance parameters, which belongs to the candidate device, and a sum of the performance parameters; and
removing the candidate device from the client devices when a difference between the importance ratio and the performance ratio is greater than a default value.

16. The federated learning system according to claim 10, wherein the central device performing updating the global model based on the trained models comprises:
assigning a plurality of weight values to the trained models respectively according to more than one importance parameters belonging to the target devices among the importance parameters provided by the client devices; and
updating the global model according to the weight values and the trained models.

17. The federated learning system according to claim 10, wherein each of the importance parameters comprises a loss value or a gradient value of a local model of a respective one of among the client devices.

18. The federated learning system according to claim 10, wherein each of the performance parameters comprises at least one of an inferring duration, an inferring speed of using a local model and connection information of a respective one of the client devices.
